(19) United States
(12) Patent Application Publication
(10) Pub. No.: US 2025/0301211 A1
(43) Pub. Date: Sep. 25, 2025

(54) CONTROL APPARATUS, CONTROL METHOD, AND STORAGE MEDIUM

(71) Applicant: CANON KABUSHIKI KAISHA, Tokyo (JP)

(72) Inventor: AKIHIKO ISHIZU, Kanagawa (JP)

(21) Appl. No.: 19/085,927

(22) Filed: Mar. 20, 2025

(30) Foreign Application Priority Data
Mar. 25, 2024 (JP) 2024-048764

(51) Int. Cl. H04N 23/62

(52) U.S. Cl. CPC H04N 23/62

(57) ABSTRACT

A control apparatus that controls a plurality of image capturing apparatuses including at least a first image capturing apparatus and a second image capturing apparatus includes a reception unit that receives a change in the setting values for one or more of the plurality of image capturing apparatuses, and a change unit that, upon reception of the received change in the setting values of the plurality of image capturing apparatuses, changes a first setting value of the first image capturing apparatus to a second setting value at which the transmission data size is smaller than the transmission data size at the first setting value, and then changes the setting value of the second image capturing apparatus to a third setting value at which the transmission data size increases, wherein the obtaining unit and the change unit are implemented by one or more processors.

### BACKGROUND

### Field

The present disclosure relates to a control apparatus, a control method, and a storage medium.

### Description of the Related Art

In recent years, a live streaming function is known. The live streaming function is implemented by equipping an image capturing apparatus such as a digital camera with a wireless communication function, connecting an information processing apparatus to the image capturing apparatus, and transmitting video image data captured by the image capturing apparatus and audio data recorded by the image capturing apparatus to an external apparatus such as a distribution server via the information processing apparatus.

It is also possible to perform multi-angle streaming by combining pieces of video image data captured by a plurality of image capturing apparatuses and pieces of audio data recorded by the plurality of image capturing apparatuses into one piece of video image data and audio data by using an information processing apparatus. In the case of using the plurality of image capturing apparatuses, it is possible to employ a configuration in which the plurality of image capturing apparatuses and the information processing apparatus are connected to a single local area network (LAN) built at home or the like, to thereby perform live streaming.

However, in a case where a plurality of image capturing apparatuses distributes data as in multi-angle streaming, the image capturing apparatuses simultaneously use a bandwidth of a single LAN, so that a communication load increases and a delay or a processing lag is more likely to occur.

In this regard, for example, Japanese Patent Application Laid-Open No. 2020-53953 discusses a method for dynamically changing the resolution of data transmitted from each image capturing apparatus so as to prevent the communication load from increasing when a plurality of image capturing apparatuses is detected within a single LAN during multi-angle streaming.

However, it is often difficult even for an image capturing apparatuses that can dynamically change resolution to change the resolution from a mid-frame while generating data corresponding to one Group of Pictures (GOP). Specifically, in a case where an I-frame is generated with a certain resolution, the resolution of a B-frame or a P-frame cannot be changed to a different resolution based on the I-frame. Accordingly, in the method discussed in Japanese Patent Application Laid-Open No. 2020-53953, a period of time for data generation corresponding to one GOP, during which a plurality of image capturing apparatuses can distribute data with high resolution, may occur during change of the resolution. In this case, the communication load increases.

### SUMMARY

In view of the above, the present disclosure is directed to reducing the possibility of increasing a communication load by performing control to prevent occurrence of a period of time during which a plurality of image capturing apparatuses distributes data with high resolution during change of a resolution.

According to an aspect of the present disclosure, a control apparatus that controls a plurality of image capturing apparatuses including at least a first image capturing apparatus and a second image capturing apparatus includes an obtaining unit that obtains video image data from each of the first image capturing apparatus and the second image capturing apparatus, the first image capturing apparatus and the second image capturing apparatus having different setting values related to a transmission data size, a reception unit that receives a change in the setting values for one or more of the plurality of image capturing apparatuses; and, a change unit that, upon reception of the received change in the setting values of the plurality of image capturing apparatuses, changes a first setting value of the first image capturing apparatus to a second setting value at which the transmission data size is smaller than the transmission data size at the first setting value, and then changes the setting value of the second image capturing apparatus to a third setting value at which the transmission data size increases, wherein the obtaining unit and the change unit are implemented by one or more processors.

Further features of the present disclosure will become apparent from the following description of exemplary embodiments with reference to the attached drawings.

### BRIEF DESCRIPTION OF THE DRAWINGS

FIG. 1 is a block diagram illustrating a configuration of a digital camera according to an exemplary embodiment of the present disclosure.

FIG. 2 is a block diagram illustrating a configuration of a smart device according to the exemplary embodiment.

FIG. 3 illustrates a system configuration according to the exemplary embodiment.

FIGS. 4A, 4B, and 4C each illustrate an example of a user interface (UI) for the smart device according to the exemplary embodiment.

FIGS. 5A and 5B are sequence diagrams each illustrating processing to be performed by digital cameras and the smart device according to the exemplary embodiment.

FIG. 6 is a flowchart illustrating processing to be performed by the smart device according to the exemplary embodiment.

### DESCRIPTION OF THE EMBODIMENTS

An exemplary embodiment of the present disclosure will be described in detail below with reference to the attached drawings. The exemplary embodiment to be described below is an example of the present disclosure that may be implemented, and can appropriately be modified or altered based on a configuration and various conditions of an apparatus to which the present disclosure is applied.

### <Configuration of Digital Camera 100>

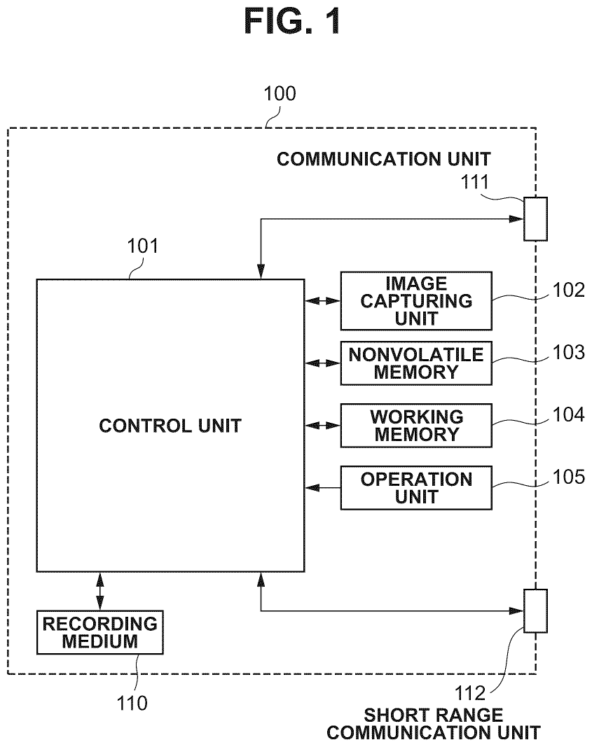

FIG. 1 is a block diagram illustrating a configuration example of a digital camera 100 that is an example of an image capturing apparatus to which an exemplary embodiment of the present disclosure is applied. While the present exemplary embodiment describes a digital camera as an example of the image capturing apparatus, the image capturing apparatus is not limited to a digital camera. Examples of the image capturing apparatus may include a portable media player, what is called a tablet device, and a personal computer.

A control unit 101 controls each unit of the digital camera 100 based on an input signal and a program to be described below. Instead of using the control unit 101 to control the entire image capturing apparatus, processing may be shared among a plurality of pieces of hardware to control the entire image capturing apparatus. A control unit is a CPU or processor.

An image capturing unit 102 includes, for example, an optical lens unit, an optical system that controls an aperture, zooming, focusing, and the like, and an image sensor that converts light (video image) having entered through the optical lens unit into an electrical video image signal. In general, a complementary metal oxide semiconductor (CMOS) sensor or a charge-coupled device (CCD) sensor is used as the image sensor. The control unit 101 controls the image capturing unit 102 so that the image sensor can convert object light imaged by a lens included in the image capturing unit 102 into an electrical signal, and the image capturing unit 102 can perform noise reduction processing and the like and output digital data as image data. In the digital camera 100 according to the present exemplary embodiment, the control unit 101 encodes the image data and stores the encoded image data as a file in a recording medium 110 based on Design Rule for Camera File (DCF) system standards.

A nonvolatile memory 103 is an electrically erasable and recordable nonvolatile memory and stores a program to be executed by the control unit 101 as described below and the like. A working memory 104 is used as a buffer memory that temporarily holds image data captured by the image capturing unit 102, an image display memory for a display unit, a work area for the control unit 101, and the like.

An operation unit 105 is used to receive an instruction from a user for the digital camera 100. Examples of the operation unit 105 include a power button for the user to issue an instruction to turn ON or OFF the digital camera 100, and a release switch for the user to issue an image capturing instruction. The release switch includes SW1 and SW2 for detecting a pressed state in two steps. When the release switch is in what is called a half-pressing state, the SW1 turns ON. Accordingly, the digital camera 100 receives an instruction for preparing image capturing processing, such as autofocus (AF) processing, automatic exposure (AE) processing, automatic white balance (AWB) processing, and flash preliminary emission (EF) processing. When the release switch is in what is called a full-pressing state, the SW2 turns ON. Accordingly, the digital camera 100 receives an image capturing instruction.

The display unit displays a viewfinder image during image capturing, displays captured image data, displays characters used for an interactive operation, and the like. The display unit need not necessarily be incorporated in the digital camera 100. The digital camera 100 may be connected to the display unit, which can be located inside or outside of the digital camera 100, and may include at least a display control function of controlling display of the display unit.

A microphone is used to input audio. In the digital camera 100 according to the present exemplary embodiment, the input audio is transmitted as audio data to a smart device 200 via a communication unit 111.

The recording medium 110 can record the image data file output from the image capturing unit 102. The recording medium 110 may be detachably mounted on the digital camera 100, or may be incorporated in the digital camera 100. In other words, the digital camera 100 may include at least a means for accessing the recording medium 110.

The communication unit 111 is an interface for connecting to an information processing apparatus. The digital camera 100 according to the present exemplary embodiment can exchange data with the information processing apparatus via the communication unit 111. For example, image data generated by the image capturing unit 102 can be transmitted to the information processing apparatus via the communication unit 111. In the present exemplary embodiment, the communication unit 111 includes an interface for establishing communication with the information processing apparatus through what is called a wireless local area network (LAN) based on Institute of Electrical and Electronics Engineers (IEEE) 802.11 standards. The control unit 101 controls the communication unit 111 to thereby implement wireless communication with the information processing apparatus.

A short range communication unit 112 includes, for example, an antenna for wireless communication, a modulation/demodulation circuit for processing radio signals, and a communication controller. The short range communication unit 112 outputs modulated radio signals from the antenna and demodulates radio signals received by the antenna, thereby implementing short range communication based on IEEE 802.15 standards (what is called Bluetooth®). In the present exemplary embodiment, Bluetooth® Low Energy version 4.0, which is low in power consumption, is adopted for Bluetooth® communication. The Bluetooth® communication has a narrower communicable range (i.e., a shorter communication distance) than wireless LAN communication. In addition, the communication speed of the Bluetooth® communication is slower than that of the wireless LAN communication. On the other hand, the Bluetooth® communication consumes less power than the wireless LAN communication. The digital camera 100 according to the present exemplary embodiment can exchange data with the information processing apparatus via the short range communication unit 112. For example, upon reception of an image capturing instruction from the information processing apparatus, the digital camera 100 controls the image capturing unit 102 to perform an image capturing operation. Upon reception of an instruction to exchange data via wireless LAN communication, the digital camera 100 controls the communication unit 111 to start wireless LAN communication.

### <Internal Configuration of Smart Device 200>

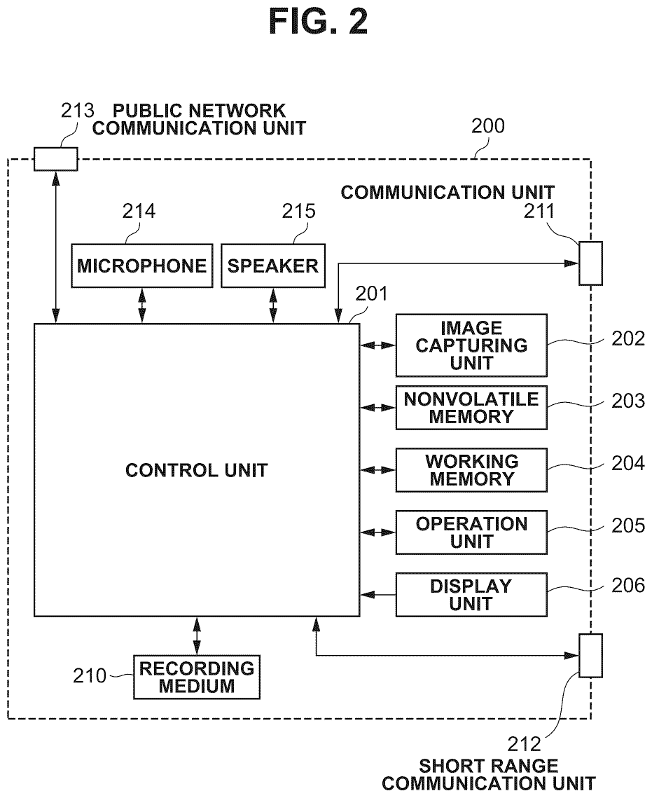

FIG. 2 is a block diagram illustrating a configuration example of the smart device 200 that is an example of the information processing apparatus that communicates with the digital camera 100 according to the present exemplary embodiment. The term “smart device” refers to a mobile terminal such as a smartphone or a tablet device. While the present exemplary embodiment describes the smart device as an example of the information processing apparatus, the information processing apparatus is not limited thereto. Examples of the information processing apparatus may include a digital camera, a printer, a television set, and a personal computer equipped with a wireless communication function.

A control unit 201 controls each unit of the smart device 200 based on an input signal and a program to be described below. Instead of using the control unit 201 to control the entire information processing apparatus, processing may be shared among a plurality of pieces of hardware to control the entire information processing apparatus.

An image capturing unit 202 converts object light imaged by a lens included in the image capturing unit 202 into an electrical signal, performs noise reduction processing and the like, and outputs digital data as image data. Captured image data is stored in a buffer memory, and then the control unit 201 performs predetermined arithmetic processing or encoding processing on the image data and stores the processed image data as a file in a recording medium 210.

A nonvolatile memory 203 is an electrically erasable and recordable nonvolatile memory. The nonvolatile memory 203 stores an operating system (OS) as basic software to be executed by the control unit 201, and an application for implementing an applied function in conjunction with the OS. In the present exemplary embodiment, the nonvolatile memory 203 also stores an application for communicating with the digital camera 100.

A working memory 204 is used as an image display memory for a display unit 206, a work area for the control unit 201, and the like. An operation unit 205 is used to receive an instruction for the smart device 200 from the user. Examples of the operation unit 205 include a power button for the user to issue an instruction to turn ON or OFF the smart device 200, and an operation member such as a touch panel formed on the display unit 206. The display unit 206 displays image data and displays characters used for an interactive operation. The display unit 206 need not necessarily be included in the smart device 200. The smart device 200 may be connectable to the display unit 206 and may include at least a display control function for controlling display of the display unit 206. The operation unit 205 and the display unit 206 constitute a user interface (UI) for the smart device 200.

The recording medium 210 can record the image data output from the image capturing unit 202.

The recording medium 210 may be detachably mounted on the smart device 200, or may be incorporated in the smart device 200. In other words, the smart device 200 may include at least a means for accessing the recording medium 210.

A communication unit 211 is an interface for connecting to the image capturing apparatus and an external apparatus.

The smart device 200 according to the present exemplary embodiment can exchange data with the digital camera 100 and the external apparatus via the communication unit 211. In the present exemplary embodiment, the communication unit 211 is an antenna, and the control unit 101 can be connected to the digital camera 100 via the antenna. The smart device 200 may be directly connected to the digital camera 100, or may be connected to the digital camera 100 via an access point. A protocol for communicating data is Hypertext Transfer Protocol (HTTP), for example.

In addition, Picture Transfer Protocol over Internet Protocol (PTP/IP) through a wireless LAN can also be used.

The configuration for communicating with the digital camera 100 is not limited thereto. For example, the communication unit 211 can include a wireless communication module such as an infrared communication module, a Bluetooth® communication module, and a wireless universal serial bus (USB). In addition, a wired connection using a USB cable, High-Definition Multimedia Interface (HDMI®), IEEE 1394, Ethernet, and the like may also be used.

A short range communication unit 212 is a communication unit for implementing short range communication. The short range communication unit 212 includes an antenna for wireless communication, a modulation/demodulation circuit for processing radio signals, and a communication controller. The short range communication unit 212 outputs modulated radio signals from the antenna and demodulates radio signals received by the antenna, thereby implementing short range communication. In the present exemplary embodiment, short range communication based on IEEE 802.15 standards (what is called Bluetooth®) is implemented. Contactless short range communication to be implemented by the short range communication unit 112 is not limited to Bluetooth®. Any other wireless communication may also be used.

A public network communication unit 213 is an interface used to establish public wireless communication.

The smart device 200 can make a phone call to another device via the public network communication unit 213. In this case, the control unit 201 inputs and outputs audio signals via a microphone 214 and a speaker 215, thereby implementing the phone call. In the present exemplary embodiment, the public network communication unit 213 is an antenna, and the control unit 101 can be connected to a public network via the antenna. A single antenna can be used as both the communication unit 211 and the public network communication unit 213. As above, the smart device 200 according to the present exemplary embodiment has been described.

### <System Configuration>

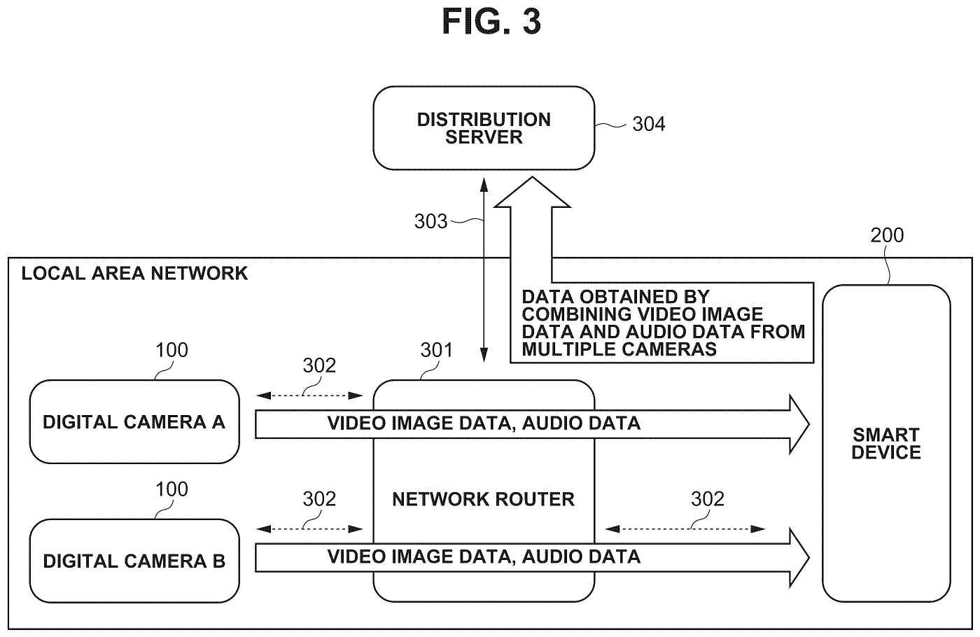

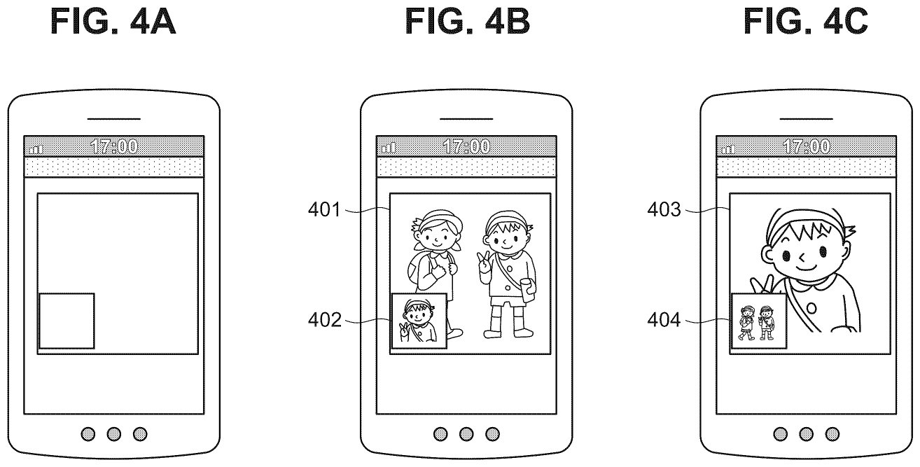

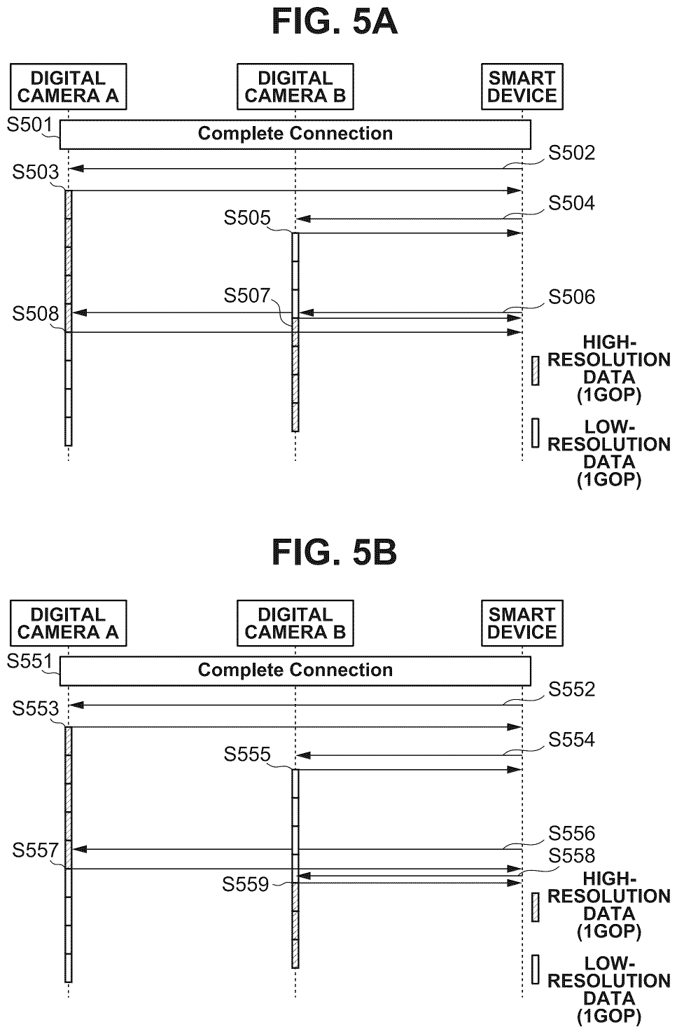

FIG. 3 illustrates a system configuration for performing live streaming in which the smart device 200 accesses a plurality of digital cameras 100 and a distribution server 304 via a network. FIGS. 4A, 4B, and 4C each illustrate an example of a UI for the smart device 200 to perform live streaming. It is assumed that the smart device 200 stores an address for accessing the distribution server 304. FIGS. 5A and 5B are examples of sequence diagrams each illustrating processing to be performed by the plurality of digital cameras 100 (digital camera A, digital camera B) and the smart device 200 according to the present exemplary embodiment. The distribution server 304 is an example of a management apparatus.

A system configuration according to the present exemplary embodiment will be described with reference to FIG. 3 and FIGS. 4A to 4C.

The smart device 200 is connected to the plurality of digital cameras 100 via a network router 301. In this case, the network router 301 functions as a Wi-Fi® access point and builds a LAN. The digital camera 100 and the smart device 200 each function as a Wi-Fi® client and connect to the LAN built by the network router 301. While the present exemplary embodiment describes an example where communication 302 is established via Wi-Fi®, the communication 302 may use a wired connection such as Ethernet.

The smart device 200 is connected to the distribution server 304 via the communication 302 and a public line 303. The smart device 200 receives (or obtains) video image data and audio data from the plurality of digital cameras 100, combines the received data, and transmits the combined data to the distribution server 304. Thus, multi-angle streaming is implemented by transmitting the video image data and audio data of the plurality of digital cameras 100 to the distribution server 304.

When the smart device 200 is connected to the plurality of digital cameras 100, the smart device 200 displays a screen as illustrated in FIG. 4A. Upon receiving the video image data and audio data from the plurality of digital cameras 100, the smart device 200 combines the received data and displays a display screen as illustrated in FIG. 4B. In a case where Picture-in-Picture (PiP) streaming as illustrated in FIG. 4B is performed, it is possible to employ a screen configuration in which a screen that the user mainly views is set as a main screen 401 and a screen other than the main screen 401 is set as a sub-screen 402. In other words, the area (an example of a main screen area) of the main screen 401 may be larger than the area (an example of a sub-screen area) of the sub-screen 402.

Herein, the digital camera 100 that is transmitting data to be displayed on the main screen 401 is referred to as the digital camera A and the digital camera 100 that is transmitting data to be displayed on the sub-screen 402 is referred to as the digital camera B. In this case, when high-resolution data is streamed from both the digital camera A and the digital camera B, because the digital camera A and the digital camera B use the bandwidth of a single LAN, the communication load increases and a delay or a processing lag is more likely to occur. As a countermeasure against such an issue, it is possible to employ a method for increasing resolution of transmission data from the digital camera A to be displayed (placed) on the main screen 401 and decreasing resolution of transmission data from the digital camera B to be displayed (placed) on the sub-screen 402 to decrease the communication load.

On the other hand, there may be a use case where the user wants to switch between the main screen and the sub-screen as illustrated in FIG. 4C. For example, the control unit 201 requests the digital camera A to decrease the resolution and requests the digital camera B to increase the resolution based on an operation of switching the screens as indicated by a main screen 403 and a sub-screen 404. In this case, it is often difficult even for a digital camera that can dynamically change resolution to change the resolution from a mid-frame while generating data corresponding to one Group of Pictures (GOP).

Accordingly, the resolution of the digital camera B can be increased before the resolution of the digital camera A is decreased. A possibility that data with high resolution is transmitted from the plurality of digital cameras 100 in the case of simultaneously changing the resolutions will now be described in detail with reference to FIG. 5A.

In step S501, a sequence is started when the smart device 200, the digital camera A, and the digital camera B are connected within the same LAN. In step S502, the smart device 200 requests the digital camera A to start transmission of data with high resolution. In response to this request, the digital camera A starts generation of video image data and audio data with high resolution. In step S503, the digital camera A starts transmission of the data with high resolution to the smart device 200. In step S504, the smart device 200 requests the digital camera B to start transmission of data with low resolution. In response to this request, the digital camera B starts generation of video image data and audio data with low resolution. In step S505, the digital camera B starts transmission of the data with low resolution to the smart device 200.

Upon receiving the data from the digital camera A and the digital camera B, the smart device 200 combines the data as illustrated in FIG. 4B and transmits the combined data to the distribution server 304 to thereby perform live streaming.

Next, if the smart device 200 detects a request for switching the main screen and the sub-screen as illustrated in FIG. 4C, the processing proceeds to step S506. In step S506, the smart device 200 requests the digital camera A that is generating data with high resolution to decrease the resolution, and requests the digital camera B that is generating data with low resolution to increase the resolution. Upon receiving the request, the digital camera B starts generation of data with high resolution in step S507 after completion of generation of data corresponding to one GOP, and then transmits the generated data to the smart device 200. Upon receiving the request, the digital camera A starts generation of data with low resolution in step S508 after completion of generation of data corresponding to one GOP, and then transmits the generated data to the smart device 200. Thus, during the period from step S507 and step S508, both the digital camera A and the digital camera B transmit the data with high resolution. In other words, in the case of simultaneously changing the resolutions, there is a possibility that the plurality of digital cameras 100 transmits the data with high resolution. In this case, the communication load within the LAN is increased, and a delay or a processing lag is more likely to occur.

As a countermeasure against such an issue, FIG. 5B describes a method for performing control to prevent occurrence of a period of time during which the plurality of digital cameras 100 simultaneously transmits data with high resolution when the resolution is changed which reduces a possibility of increasing the communication load.

While the present exemplary embodiment describes an example where the sub-screen is displayed in a superimposed manner on the main screen, the present exemplary embodiment is not limited to this example. For example, the sub-screen may be placed outside the main screen and displayed without being superimposed on the main screen, i.e., a plurality of screens may be displayed. While the present exemplary embodiment describes an example where the smart device 200 is connected to the distribution server 304 via the communication 302, the present exemplary embodiment is not limited to this example. For example, data to be streamed may be transmitted from the smart device 200 to the distribution server 304, and the smart device 200 may be connected to the distribution server 304 via the public network communication unit 213 of the smart device 200.

<Processing to be Performed when Transmission Resolution of Digital Camera is Changed>

FIG. 5B is an example of a sequence diagram illustrating processing to be performed by the plurality of digital cameras 100 (digital camera A, digital camera B) and the smart device 200 according to the present exemplary embodiment.

A method for performing control to prevent occurrence of a period of time during which the plurality of digital cameras 100 simultaneously transmits data with high resolution when the resolution is changed, to thereby reduce the possibility of increasing the communication load will be described with reference to FIG. 5B.

In step S551, a sequence is started when the smart device 200, the digital camera A, and the digital camera B are connected within the same LAN. In step S552, the smart device 200 requests the digital camera A to start transmission of data with high resolution. In response to this request, the digital camera A starts generation of video image data and audio data with high resolution. In step S553, the digital camera A starts transmission of the data with high resolution to the smart device 200. In step S554, the smart device 200 requests the digital camera B to start transmission of data with low resolution. In response to this request, the digital camera B starts generation of video image data and audio data with low resolution. In step S555, the digital camera B starts transmission of the data with low resolution to the smart device 200. Upon receiving the data from the digital camera A and the digital camera B, the smart device 200 combines the data as illustrated in FIG. 4B and transmits the combined data to the distribution server 304 to thereby perform live streaming.

In this case, the smart device 200 measures a period of time for generation of data corresponding to one GOP generated by each of the digital camera A and the digital camera B based on the data received from each of the digital camera A and the digital camera B. If the smart device 200 detects a request for switching the main screen and the sub-screen as illustrated in FIG. 4C, in step S556, the smart device 200 requests the digital camera A that is generating data with high resolution to decrease the resolution.

In step S557, upon receiving the request, the digital camera A starts generation of data with low resolution after completion of generation of data corresponding to one GOP, and then transmits the generated data to the smart device 200.

In step S558, the smart device 200 requests the digital camera B to increase the resolution after a lapse of a period of time for generation of data corresponding to one GOP of the digital camera A from the request in step S556. In step S559, upon receiving the request, the digital camera B generates data with high resolution after completion of generation of data corresponding to one GOP, and then transmits the generated data to the smart device 200.

The processing as described above makes it possible to change the resolution of transmission data from one of the digital cameras 100 to a low resolution and then change the resolution of transmission data from the other of the digital cameras 100 to a high resolution.

As described above, it is possible to perform control to prevent occurrence of a period of time during which the plurality of digital cameras 100 simultaneously transmits data with high resolution when the resolution is changed, to thereby reduce the possibility of increasing the communication load.

### <Processing to be Performed by Smart Device 200>

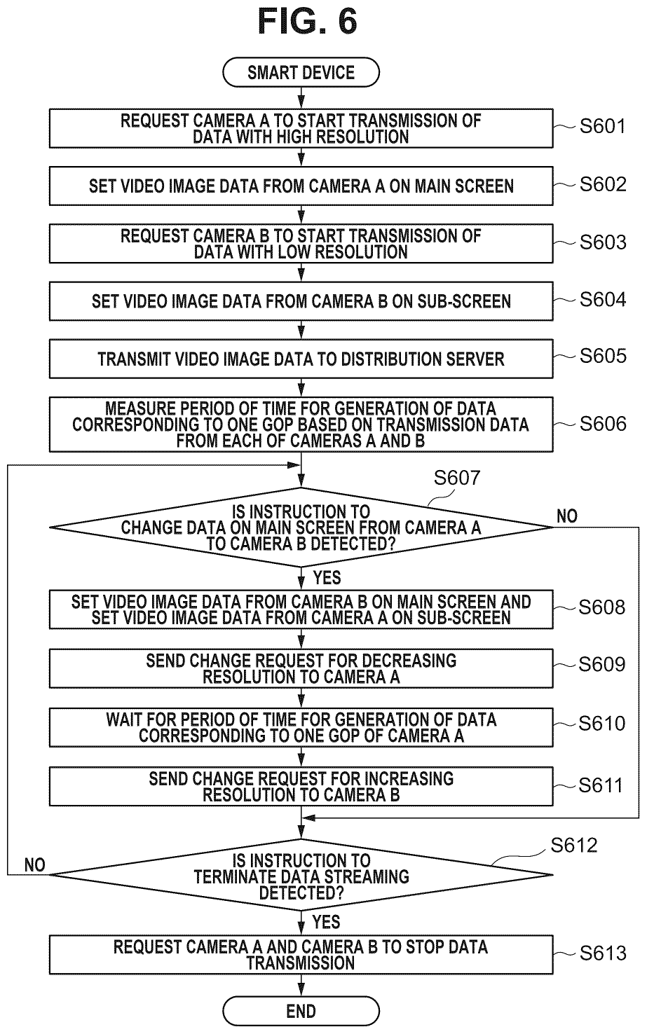

Processing to be performed by the smart device 200 according to the present exemplary embodiment will be described in detail with reference to FIGS. 4A to 4C and FIG. 6. FIG. 6 is an example of a flowchart illustrating processing to be performed by the smart device 200 in the case of instructing the plurality of digital cameras 100 according to the present exemplary embodiment to change the resolution of transmission data to prevent occurrence of a period of time during which pieces of data with high resolution are simultaneously transmitted.

The processing is started when the control unit 201 is connected to the digital camera A and the digital camera B via the communication unit 211 within the same LAN.

In step S601, the control unit 201 requests the digital camera A via the communication unit 211 to start transmission of data with high resolution. In response to the transmission request, the control unit 201 receives data from the digital camera A. Then, the processing proceeds to step S602.

In step S602, the control unit 201 sets the data received from the digital camera A via the communication unit 211 on the main screen 401 illustrated in FIG. 4B.

In step S603, the control unit 201 requests the digital camera B via the communication unit 211 to start transmission of data with low resolution. In response to the transmission request, the control unit 201 receives data from the digital camera B. Then, the processing proceeds to step S604.

In step S604, the control unit 201 sets the data received from the digital camera B via the communication unit 211 on the sub-screen 402 illustrated in FIG. 4B.

In step S605, the control unit 201 combines pieces of data received from the digital camera A and the digital camera B via the communication unit 211, and transmits the combined data to the distribution server 304. Thus, the smart device 200 implements multi-angle streaming using the plurality of digital cameras 100.

In the present exemplary embodiment, the main screen and the sub-screen are set as soon as data is received from each of the digital camera A and the digital camera B, but the present exemplary embodiment is not limited thereto. The main screen and the sub-screen may be set after reception of data from both the digital camera A and the digital camera B has started, and the received data may be set on the respective screens in any order.

In step S606, the control unit 201 measures a period of time for generation of data corresponding to one GOP based on the data received from each of the digital camera A and the digital camera B via the communication unit 211, and holds the measured periods of time in the working memory 204.

In step S607, the control unit 201 determines whether an instruction to change data displayed on the main screen from the data from the digital camera A to the data from the digital camera B is detected when the operation unit 205 is operated. If the instruction is detected (YES in step S607), the processing proceeds to step S608. In step S608, processing of switching the main screen and the sub-screen is executed.

In step S608, the control unit 201 sets the transmission data from the digital camera B on the main screen 403 and sets the transmission data from the digital camera A on the sub-screen 404 as illustrated in FIG. 4C.

In step S609, the control unit 201 sends a change request for decreasing the resolution to the digital camera A via the communication unit 211.

In step S610, the control unit 201 waits for the period of time for generation of data corresponding to one GOP of the digital camera A held in the working memory 204 in step S606, and then the processing proceeds to step S611.

In step S611, the control unit 201 sends a change request for increasing the resolution to the digital camera B via the communication unit 211. Thus, the smart device 200 instructs the digital camera A and the digital camera B to change the resolution of the transmission data to prevent occurrence of a period of time during which pieces of data with high resolution are simultaneously transmitted.

In the present exemplary embodiment, the period of time for generation of data corresponding to one GOP is measured in step S606, but this is not restrictive. For example, the period of time for generation of data corresponding to one GOP may be measured as soon as the reception of data from the digital camera A and the digital camera B has started. Alternatively, the period of time for generation of data corresponding to one GOP may be measured upon detection of a main screen switch instruction from the user.

The digital camera 100 may be configured to notify the smart device 200 of the period of time for generation of data corresponding to one GOP. Any configuration may be used as long as the smart device 200 can recognize the period of time for generation of data corresponding to one GOP of data generated by the digital camera 100.

In the present exemplary embodiment, the main screen and the sub-screen are switched in step S608, and then the instructions to change the resolutions are issued, but this is not restrictive. For example, the main screen and the sub-screen may be switched after the change of the resolutions is completed. The change of the resolutions and the switching between the main screen and the sub-screen may be performed in any order.

In step S612, the control unit 201 determines whether an instruction to terminate data streaming is detected. If the instruction is detected (YES in step S612), the processing proceeds to step S613. In step S613, the control unit 201 requests the digital camera A and the digital camera B to stop data transmission, and then the processing ends.

The present exemplary embodiment describes an example where the resolution of the digital camera A is changed from a high resolution to a low resolution. While a description is omitted in the present exemplary embodiment, processing similar to the processing described above can be performed in a case where the resolution of the digital camera B is changed from a high resolution to a low resolution, thereby making it possible to reduce the possibility of increasing the communication load.

While, in the present exemplary embodiment, the resolution is used as a setting related to a transmission data size in the description, this is not restrictive. Any setting that can make the transmission data size different, such as a bit rate and a frame rate, can be used, and by performing similar processing, it is possible to reduce the possibility of increasing the communication load.

While an example where two types of resolution, i.e., a high resolution and a low resolution, are used as the setting values for the resolution is described, this is not restrictive. Three or more types (e.g., including a medium resolution) may be used as the setting values for the resolution, or consecutive numerical values may be used.

While the present exemplary embodiment describes that the smart device 200 waits for only the period of time for generation of data corresponding to one GOP before requesting the digital camera 100 to change the resolution from the low resolution to the high resolution, this is not restrictive. For example, the smart device 200 may wait for a period of time for generation of data corresponding to one GOP or more (in other words, the smart device 200 may send an instruction to change the resolution from the high resolution to the low resolution prior to the period of time for generation of data corresponding to one GOP or more). A period of time required for changing the resolution may be measured and used, or the resolution may be changed after a lapse of a predetermined period of time. Alternatively, after detecting that the change of the resolution is completed from video image data received from one of the digital cameras 100 to which the smart device 200 has sent the request for changing the resolution, the smart device 200 may request the other of the digital cameras 100 to change the resolution. In other words, any configuration may be used as long as the digital cameras 100 is prevented from simultaneously streaming data with high resolution.

While the present exemplary embodiment describes the configuration in which two digital cameras 100 are used, by performing similar processing in a configuration where three or more digital cameras 100 are used, it is possible to reduce the possibility of increasing the communication load.

In the case of using the bandwidth of a single LAN, there is no need to decrease the resolution in an environment where there is ample bandwidth available, the communication load does not become high, and a delay or a processing lag is less likely to occur. Accordingly, a request for transmitting data with high resolution may be sent to the plurality of digital cameras 100 to check the communication load, and the exemplary embodiment of the present disclosure may be carried out only when the communication load is high.

In this case, the communication load is likely to be affected by the position of each of the digital cameras 100 and the smart device 200. For this reason, if a movement of each of the digital cameras 100 and the smart device 200 is detected, the communication load may be checked again, and it may be determined whether to carry out the exemplary embodiment of the present disclosure. Also, in a case where the number of the digital cameras 100 is increased or decreased, the communication load may be checked again, and it may be determined whether to carry out the exemplary embodiment of the present disclosure.

An example of processing to be performed by the smart device 200 is described above.

Although the present disclosure has been described in detail based on the desirable exemplary embodiment, the present disclosure is not limited to the specific exemplary embodiment, and various forms within the scope not departing from the gist of the present disclosure are also included in the present disclosure. The present disclosure also includes a case where a software program for implementing the functions of the above-described exemplary embodiment is supplied from a recording medium directly or by using wired/wireless communication to a system or apparatus including a computer capable of executing the program, and the program is executed. Thus, a program code supplied and installed to the computer to implement the functions and processes of the present disclosure by the computer also constitutes the present disclosure. In other words, a computer program for implementing the functions and processes of the present disclosure is also included in the present disclosure. In that case, the form of the program is not limited, and the program may be object code, a program executed by an interpreter, script data supplied to an OS, or the like, as long as the program has the functions of the program. The recording medium for supplying the program may be, for example, a magnetic recording medium such as a hard disk and a magnetic tape, an optical/magneto-optical storage medium, or a nonvolatile semiconductor memory. As a method of supplying the program, a method of storing the computer program constituting the present disclosure in a server on a computer network and allowing a connected client computer to download and program the computer program is also considered.

The present disclosure can also be implemented by executing the following processing: software (program) for implementing the functions of the above-described exemplary embodiment is supplied to a system or apparatus via a network or various storage media, and a computer (or a control unit or a micro processing unit (MPU)) of the system or apparatus reads and executes the program code.

While the present disclosure has been described in detail with reference to the exemplary embodiment, the present disclosure is not limited to the specific exemplary embodiment, and various forms within the scope not departing from the gist of the present disclosure are also included in the present disclosure.

The functional units of the exemplary embodiment (modifications) may be or may not be individual hardware units. The functions of two or more functional units may be implemented by common hardware. Each of a plurality of functions of one functional unit may be implemented by an individual hardware unit. Two or more functions of one functional unit may be implemented by a common hardware unit. Each functional unit may or may not be implemented by hardware such as an application specific integrated circuit (ASIC), a field programmable gate array (FPGA), or a digital signal processor (DSP). For example, the apparatus may include a processor and a memory (storage medium) in which a control program is stored. The processor may read the control program from the memory and execute the control program to implement the functions of at least some of the functional units of the apparatus.

The present disclosure can also be implemented by processing in which a program for implementing one or more functions of the above-described exemplary embodiment is supplied to a system or an apparatus via a network or a storage medium, and one or more processors in a computer of the system or the apparatus read and execute the program. The present disclosure can also be implemented by a circuit (for example, an ASIC) for implementing one or more functions.

According to the exemplary embodiment, the following configurations are disclosed.
1. A control apparatus that controls a plurality of image capturing apparatuses including at least a first image capturing apparatus and a second image capturing apparatus, the control apparatus comprising:
an obtaining unit configured to obtain video image data from each of the first image capturing apparatus and the second image capturing apparatus, the first image capturing apparatus and the second image capturing apparatus having different setting values related to a transmission data size;
a reception unit configured to receive a change in the setting values; and
a change unit configured to change the setting values in such a manner that, upon reception of the change in the setting values of the plurality of image capturing apparatuses, a first setting value of the first image capturing apparatus is changed to a second setting value at which the transmission data size is smaller than the transmission data size at the first setting value, and then the setting value of the second image capturing apparatus is changed to a third setting value at which the transmission data size increases,
wherein the obtaining unit and the change unit are implemented by the one or more processors.
2. The control apparatus according to claim 1, wherein the change unit instructs the first image capturing apparatus to change the setting value from the first setting value to the second setting value a period of time for generation of data corresponding to one Group of Pictures (GOP) or more before an instruction to change the setting value of the second image capturing apparatus to the third setting value is issued.
3. The control apparatus according to Configuration 2, further comprising a measurement unit configured to measure the period of time for generation of data corresponding to one GOP based on the video image data obtained from the plurality of image capturing apparatuses.
4. The control apparatus according to any one of Configurations 1 to 3, further comprising a generation unit configured to generate a display screen including a plurality of pieces of video image data obtained by the obtaining unit, wherein the generation unit is implemented by the one or more processors.
5. The control apparatus according to Configuration 4, wherein the display screen generated by the generation unit includes a main screen area and a sub-screen area, the sub-screen area being smaller than the main screen area.
6. The control apparatus according to Configuration 5, wherein the generation unit generates the display screen by placing, among the plurality of pieces of video image data obtained by the obtaining unit, a piece of video image data obtained based on a setting value at which the transmission data size is largest on the main screen area and a piece of video image data obtained based on another setting value on the sub-screen area.
7. The control apparatus according to Configuration 6, wherein the reception unit receives the change in the setting values based on an operation to switch between the video image data placed on the main screen area and the video image data placed on the sub-screen area.
8. The control apparatus according to any one of Configurations 5 to 7, further comprising a transmission unit configured to transmit the display screen generated by the generation unit to a management apparatus.
9. The control apparatus according to any one of Configurations 1 to 8, wherein the plurality of image capturing apparatuses is connected to a same local area network (LAN), wherein the generation unit is implemented by the one or more processors.
10. The control apparatus according to any one of Configurations 1 to 9, wherein the second setting value and the third setting value are same setting values.
11. The control apparatus according to any one of Configurations 1 to 10, wherein the setting values are setting values for resolution, and wherein the first setting value is a setting value for high resolution, and the second setting value is a setting value for low resolution, the low resolution being lower than the high resolution.
12. A control method to be executed by a computer to control a plurality of image capturing apparatuses including at least a first image capturing apparatus and a second image capturing apparatus, the control method comprising:
obtaining video image data from each of the first image capturing apparatus and the second image capturing apparatus, the first image capturing apparatus and the second image capturing apparatus having different setting values related to a transmission data size;
receiving a change in the setting values; and
changing the setting values in such a manner that, upon reception of the change in the setting values of the plurality of image capturing apparatuses, a first setting value of the first image capturing apparatus is changed to a second setting value at which the transmission data size is smaller than the transmission data size at the first setting value, and then the setting value of the second image capturing apparatus is changed to a third setting value at which the transmission data size increases.
13. A non-transitory computer-readable storage medium which stores a program for causing a computer to execute a method, the method comprising:
obtaining video image data from each of a first image capturing apparatus and a second image capturing apparatus, the first image capturing apparatus and the second image capturing apparatus having different setting values related to a transmission data size;
receiving a change in the setting values; and
changing the setting values in such a manner that, upon reception of the change in the setting values of plurality of image capturing apparatuses, a first setting value of the first image capturing apparatus is changed to a second setting value at which the transmission data size is smaller than the transmission data size at the first setting value, and then the setting value of the second image capturing apparatus is changed to a third setting value at which the transmission data size increases.

According to the present disclosure, it is possible to reduce the possibility of increasing a communication load when video data is transmitted from a plurality of image capturing apparatuses.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-048764, filed Mar. 25, 2024, which is hereby incorporated by reference herein in its entirety.

What is claimed is:

1. A control apparatus that controls a plurality of image capturing apparatuses including at least a first image capturing apparatus and a second image capturing apparatus, the control apparatus comprising:
an obtaining unit that obtains video image data from each of the first image capturing apparatus and the second image capturing apparatus, the first image capturing apparatus and the second image capturing apparatus having different setting values related to a transmission data size;
a reception unit that receives a change in the setting values for one or more of the plurality of image capturing apparatuses; and
a change unit that, upon reception of the received change in the setting values of the plurality of image capturing apparatuses, changes a first setting value of the first image capturing apparatus to a second setting value at which the transmission data size is smaller than the transmission data size at the first setting value, and then changes the setting value of the second image capturing apparatus to a third setting value at which the transmission data size increases,
wherein the obtaining unit and the change unit are implemented by one or more processors.

2. The control apparatus according to claim 1, wherein the change unit instructs the first image capturing apparatus to change the setting value from the first setting value to the second setting value to a period of time for generation of data corresponding to one Group of Pictures (GOP) or more before an instruction to change the setting value of the second image capturing apparatus to the third setting value is issued.

3. The control apparatus according to claim 2, further comprising a measurement unit that measures the period of time for generation of data corresponding to one GOP based on the video image data obtained from the plurality of image capturing apparatuses.

4. The control apparatus according to claim 1, further comprising a generation unit that generates a display screen including a plurality of pieces of obtained video image data.

5. The control apparatus according to claim 4, wherein the generated display screen includes a main screen area and a sub-screen area, the sub-screen area being smaller than the main screen area.

6. The control apparatus according to claim 5,
wherein the generation unit generates the display screen by placing a piece of video image data obtained based on a setting value at which the transmission data size is largest in the main screen area and a piece of video image data obtained based on another setting value in the sub-screen area, and
wherein the generation unit is implemented by the one or more processors.

7. The control apparatus according to claim 6, wherein the reception unit receives the change in the setting values based on an operation to switch between the video image data placed on the main screen area and the video image data placed on the sub-screen area.

8. The control apparatus according to claim 5, further comprising a transmission unit that transmits the display screen generated by the generation unit to a management apparatus
wherein the transmission unit is implemented by the one or more processors.

9. The control apparatus according to claim 1, wherein the plurality of image capturing apparatuses is connected to a same local area network (LAN).

10. The control apparatus according to claim 1, wherein the second setting value and the third setting value are same setting values.

11. The control apparatus according to claim 1,
wherein the setting values are setting values for resolution, and
wherein the first setting value is a setting value for a first resolution, and the second setting value is a setting value for a second resolution being a lower resolution than the first resolution.

12. A control method to be executed by a computer to control a plurality of image capturing apparatuses including at least a first image capturing apparatus and a second image capturing apparatus, the control method comprising:
obtaining video image data from each of the first image capturing apparatus and the second image capturing apparatus, the first image capturing apparatus and the second image capturing apparatus having different setting values related to a transmission data size;
receiving a change in the setting values; and
changing the setting values in such a manner that, upon reception of the change in the setting values of the plurality of image capturing apparatuses, a first setting value of the first image capturing apparatus is changed to a second setting value at which the transmission data size is smaller than the transmission data size at the first setting value, and then the setting value of the second image capturing apparatus is changed to a third setting value at which the transmission data size increases.

13. A non-transitory computer-readable storage medium which stores a program for causing a computer to execute a method, the method comprising:
obtaining video image data from each of a first image capturing apparatus and a second image capturing apparatus, the first image capturing apparatus and the second image capturing apparatus having different setting values related to a transmission data size;
receiving a change in the setting values; and
changing the setting values in such a manner that, upon reception of the change in the setting values of plurality of image capturing apparatuses, a first setting value of the first image capturing apparatus is changed to a second setting value at which the transmission data size is smaller than the transmission data size at the first setting value, and then the setting value of the second image capturing apparatus is changed to a third setting value at which the transmission data size increases.
